(19) United States
(12) Patent Application Publication
(10) Pub. No.: US 2026/0099459 A1
(43) Pub. Date: Apr. 9, 2026

(54) COMMUNICATION MODULE

(71) Applicant: Murata Manufacturing Co., Ltd., Nagaokakyo-shi (JP)

(72) Inventors: Kazuhiro NAKAMUTA, Nagaokakyo-shi (JP); Satoshi MATSUMURA, Nagaokakyo-shi (JP); Takahiro KATAMATA, Nagaokakyo-shi, (JP)

(21) Appl. No.: 19/361,099

(22) Filed: Oct. 17, 2025

Related U.S. Application Data
(63) Continuation of application No. PCT/JP2024/004286, filed on Feb. 8, 2024.

(30) Foreign Application Priority Data
Apr. 19, 2023 (JP) 2023-068569

(51) Int. Cl. G06F 13/42

(52) U.S. Cl. CPC G06F 13/4282; G06F 2213/0012

(57) ABSTRACT

A first slave device and a second slave device to which different slave identifiers are added are connected to a serial bus. The second slave device includes a second storage unit including multiple registers and a second serial interface unit that receives a command in which the slave identifier of the second slave device is set via the serial bus and that sets a result of a process corresponding to the received command in at least one register in the second storage unit.

### CROSS REFERENCE TO RELATED APPLICATION

This is a continuation of International Application No. PCT/JP2024/004286 filed on Feb. 8, 2024 which claims priority from Japanese Patent Application No. 2023-068569 filed on Apr. 19, 2023. The contents of these applications are incorporated herein by reference in their entireties.

### BACKGROUND OF THE DISCLOSURE

### Field of the Disclosure

The present disclosure relates to a communication module.

### Description of the Related Art

A technique to perform data communication between a master device and multiple slave devices via a serial bus in a radio-frequency communication module is publicly known (refer to U.S. Patent Application Publication No. 2016/0242057). A slave identifier (ID) for identification is allocated to each of the multiple slave devices. Upon transmission of a command in which the slave ID specifying one of the multiple slave devices is set by the master device via the serial bus, the one slave device having the slave ID set in the command performs a process corresponding to the command.

Each of the multiple slave devices includes a monitor unit that receives a command in which the slave ID specifying another slave device is set and that stores the received command. The monitor unit of each of the multiple slave devices is capable of receiving the command for another slave device to modify the setting in the corresponding slave device in accordance with the command.

### BRIEF SUMMARY OF THE DISCLOSURE

A reception error may occur when one slave device receives a command in which the slave ID of the slave device is set. If the reception error occurs, the corresponding slave device does not perform setting change in response to the command. In this case, if the monitor unit in another slave device receives the command and performs the process in accordance with the command, inconsistency may occur in the content of settings between the two slave devices.

It is a possible benefit of the present disclosure to provide a communication module capable of suppressing occurrence of the inconsistency in the content of setting between the slave devices when a command transmitted to one slave device is also received by another slave device.

According to one aspect of the present disclosure, a communication module is provided, which includes a first slave device and a second slave device which are connected to a serial bus and to which different slave identifiers are added. The second slave device includes a second storage unit including multiple registers and a second serial interface unit that receives a command in which the slave identifier of the second slave device is set via the serial bus and that sets a result of a process corresponding to the received command in at least one register in the second storage unit. The first slave device includes a first storage unit including multiple registers, a second sub storage unit including at least one register, a first serial interface unit that receives a command in which the slave identifier of the first slave device is set via the serial bus and that sets a result of a process corresponding to the received command in at least one register in the first storage unit, and a second sub serial interface unit that receives a command in which the slave identifier of the second slave device is set via the serial bus and that sets a result of a process corresponding to the received command in the at least one register in the second sub storage unit. The second serial interface unit has a function to detect any reception error of a command and, upon detection of the reception error, does not perform a process to set the value of the register in the second storage unit, which corresponds to the command in which the reception error is detected. The second sub serial interface unit has a function to detect any reception error of a command and, upon detection of the reception error, does not perform a process to set the value of the register in the second sub storage unit, which corresponds to the command in which the reception error is detected.

Since the second sub serial interface unit in the first slave device does not perform the process to set the value of the register in the second sub storage unit upon detection of any reception error of the command, like the second serial interface unit in the second slave device, inconsistency in the content of setting is not likely to occur between the first slave device and the second slave device.

### BRIEF DESCRIPTION OF THE SEVERAL VIEWS OF THE DRAWINGS

FIG. 1 is a block diagram of a communication module according to a first embodiment.

FIG. 2A and FIG. 2B are diagrams indicating multiple registers included in a second storage unit and a second sub storage unit, respectively.

FIG. 3 is a block diagram of a first slave device and a second slave device.

FIG. 4 is a flowchart indicating a processing procedure performed by a second sub serial interface unit in the first slave device.

FIG. 5 is a block diagram of the communication module according to a comparative example.

FIG. 6 is a flowchart indicating a processing procedure performed by the second sub serial interface unit in the first slave device in the communication module according to a second embodiment.

FIG. 7A is a block diagram of the part of the first slave device in the communication module according to a third embodiment.

FIG. 7B is a truth table of a setting value PA_Enable_Original, an output value Valid, and an output value PA_Enable.

### DETAILED DESCRIPTION OF THE DISCLOSURE

### First Embodiment

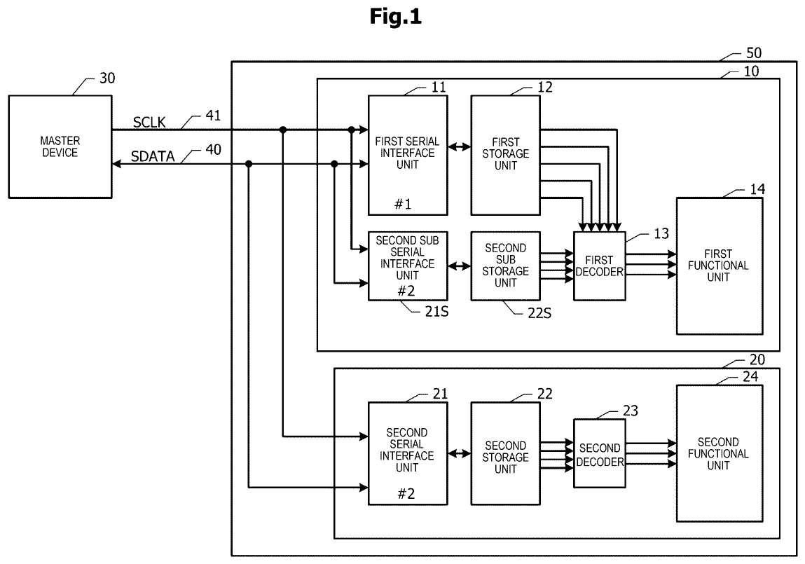

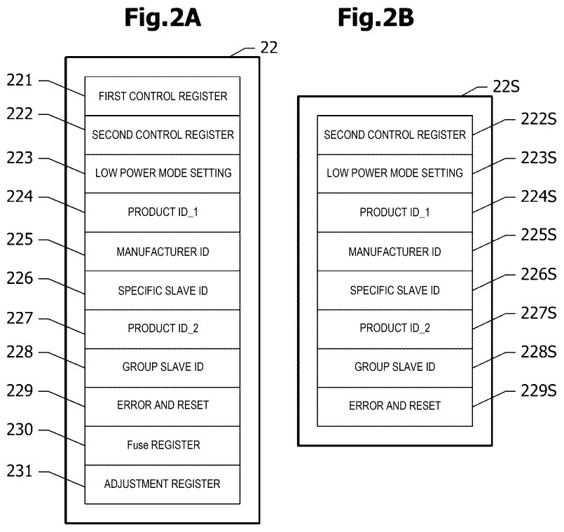

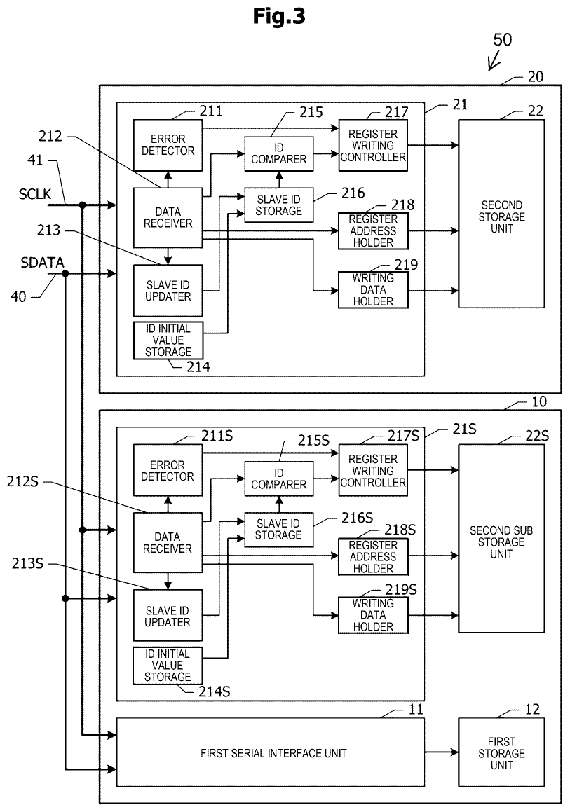

A communication module according to a first embodiment will now be described with reference to FIG. 1, FIG. 2, and FIG. 3.

FIG. 1 is a block diagram of a communication module 50 according to the first embodiment. A master device 30, a first slave device 10, and a second slave device 20 are connected to a serial bus 40. Communication of serial data (SDATA) including a variety of information, for example, commands for various settings, operations, and so on and response messages to the commands, is performed between the master device 30 and the first slave device 10 and between the master device 30 and the second slave device 20. A clock signal (SCLK) is transmitted from the master device 30 to the first slave device 10 and the second slave device 20 via a clock line 41.

A slave ID for identifying one slave device from multiple slave devices is allocated to each of the first slave device 10 and the second slave device 20. The IDs allocated to the first slave device 10 and the second slave device 20 are respectively denoted by #1 and #2. The slave ID for identifying the destination slave device of a command is included in the command transmitted from the master device 30 via the serial bus 40.

The second slave device 20 includes a second serial interface unit 21, a second storage unit 22, a second decoder 23, and a second functional unit 24. The second storage unit 22 includes multiple registers for setting a variety of information. The second serial interface unit 21 receives a command via the serial bus 40, determines whether the slave ID set in the received command is the slave ID #2 of the second slave device 20, and performs a process corresponding to the command in which the slave ID #2 of the second slave device 20 is set.

When the received command is a command to set a value in a register, the second serial interface unit 21 writes the value specified in the received command in the corresponding register in the second storage unit 22. When the received command is a command to read the value of a register, the second serial interface unit 21 reads the value of the corresponding register in the second storage unit 22 and returns a message indicating the value of the register to the master device 30. When the received command is a command to change the slave ID, the second serial interface unit 21 changes the slave ID #2 of the second slave device 20 to the value specified in the command. The value of the slave ID #2 after change is stored in a slave ID storage 216 in the second serial interface unit 21, which is described below with reference to FIG. 3.

The second decoder 23 decodes the values of the multiple registers in the second storage unit 22 and transmits control values featuring the operations of the second functional unit 24 to the second functional unit 24. The second functional unit 24 is, for example, an antenna switch with which multiple power amplifiers are connected to multiple antennas. The second functional unit 24 is set to, for example, a state in which one of the multiple power amplifiers is connected to one of the multiple antenna elements in accordance with the control value from the second decoder 23.

The first slave device 10 includes a first serial interface unit 11, a first storage unit 12, a first decoder 13, a first functional unit 14, a second sub serial interface unit 21S, and a second sub storage unit 22S. The first storage unit 12 includes multiple registers for setting a variety of information. The first serial interface unit 11 receives a command in which the slave ID #1 specifying the first slave device 10 is set and performs a process corresponding to the command.

When the received command is the command to set a value in a register, the first serial interface unit 11 writes the value specified in the received command in the corresponding register in the first storage unit 12. When the received command is the command to read the value of a register, the first serial interface unit 11 reads the value of the corresponding register in the first storage unit 12 and returns a message indicating the value of the register to the master device 30. When the received command is the command to change the slave ID, the first serial interface unit 11 changes the slave ID #1 of the first slave device 10 to the value specified in the command. The value of the slave ID #1 after change is stored in a slave ID storage in the first serial interface unit 11.

The second sub serial interface unit 21S receives a command in which the slave ID #2 specifying the second slave device 20 is set and performs a process corresponding to the command. In other words, the first slave device 10 receives not only the command for the first slave device 10 but also the command for the second slave device 20 other than the first slave device 10 and performs the processes corresponding to the commands.

When the received command is the command to set a value in a register, the second sub serial interface unit 21S writes the value specified in the received command in the corresponding register in the second sub storage unit 22S. When the received command is the command to change the slave ID, the second sub serial interface unit 21S changes the slave ID #2 in the second sub serial interface unit 21S to the value specified in the command. The value of the slave ID #2 after change is stored in a slave ID storage 216S in the second sub serial interface unit 21S, which will be described below with reference to FIG. 3.

The first decoder 13 decodes the values of the various registers in the first storage unit 12 and the second sub storage unit 22S and transmits control values featuring the operations of the first functional unit 14 to the first functional unit 14. The first functional unit 14 is, for example, a power amplifier. The control values to be supplied to the power amplifier include, for example, a control value that causes the first slave device 10 to work in a normal power mode, a control value that causes the first slave device 10 to work in a low power mode, and so on.

FIG. 2A is a diagram indicating the multiple registers included in the second storage unit 22. The meaning of each of the multiple registers will now be described. The second storage unit 22 includes a first control register 221 and a second control register 222 for control of the second functional unit 24 (for example, the antenna switch). The value of the second control register 222 is also used for control of the first functional unit 14 (the power amplifier).

The second storage unit 22 includes other multiple registers. These registers will now be simply described. A low power mode setting register 223 is a register to set a register update trigger and the power mode. A product ID_1 register 224 is a register in which a product ID is set and a manufacturer ID register 225 is a register in which a manufacturer ID is set. A specific slave ID register 226 is a register in which the slave ID is set. A product ID_2 register 227 is a register in which an enhanced product ID is set. A group slave ID register 228 is a register in which a group slave ID is set. An error and reset register 229 includes an error flag and a flag for soft reset. A Fuse register 230 is a register for fuse control. An adjustment register 231 is a register for analog adjustment.

FIG. 2B is a diagram indicating the multiple registers included in the second sub storage unit 22S. The second sub storage unit 22S includes a register used for control of the first functional unit 14 (FIG. 1), a register necessary for change of the slave ID, a register used for error detection, and so on, among the multiple registers in the second storage unit 22. Specifically, the second sub storage unit 22S includes a second control register 222S, a low power mode setting register 223S, a product ID_1 register 224S, a manufacturer ID register 225S, a specific slave ID register 226S, a product ID_2 register 227S, a group slave ID register 228S, and an error and reset register 229S. The meanings of these registers are the same as the meanings of the corresponding registers in the second storage unit 22.

The registers corresponding to the first control register 221, the Fuse register 230, and the adjustment register 231, among the registers in the second storage unit 22, are not included in the second sub storage unit 22S. The values of the registers corresponding to the first control register 221, the Fuse register 230, and the adjustment register 231 are not used for control of the first functional unit 14 (FIG. 1) and so on. For example, the second sub storage unit 22S includes at least the registers necessary for control of the first functional unit 14. Although the second sub storage unit 22S does not necessarily include the registers that are not required for control of the first functional unit 14, the second sub storage unit 22S may include the registers that are not required for control of the first functional unit 14.

FIG. 3 is a block diagram of the first slave device 10 and the second slave device 20. First, the functions of the second serial interface unit 21 in the second slave device 20 will be described. A data receiver 212 receives the command transmitted via the serial bus 40. An error detector 211 detects any error of the received command. For example, an error detecting code, such as a parity bit, is added to the command. The error detector 211 detects any reception error of the command based on the error detecting code and supplies the result of error detection to a register writing controller 217.

An initial value of the slave ID #2 of the second slave device 20 is stored in an ID initial value storage 214. Upon resetting of the second slave device 20, the initial value of the slave ID is set in the slave ID storage 216. If no error is detected in the received command, the command is a command to update the slave ID, and the destination of the command is the current slave ID of the second slave device 20, a slave ID updater 213 updates the value of the slave ID stored in the slave ID storage 216 to the value specified in the command. For the subsequent commands, the slave IDs of the destinations of the commands are compared with the slave IDs after update. The value stored in the slave ID storage 216 is the same as the value stored in the specific slave ID register 226 (FIG. 2A) in the second storage unit 22.

An ID comparer 215 compares the value of the slave ID set in the command received by the data receiver 212 with the value of the slave ID stored in the slave ID storage 216 to supply the result of comparison to the register writing controller 217.

When the received command is a command to rewrite the value of the register, the data receiver 212 stores the address of the target register in the second storage unit 22 in a register address holder 218 based on the content of the received command. In addition, the data receiver 212 stores the value (data) to be set in a writing data holder 219 based on the content of the command.

If no error is detected by the error detector 211 and the result of comparison by the ID comparer 215 is “consistency”, the register writing controller 217 writes the data stored in the writing data holder 219 to the register specified by the address stored in the register address holder 218. If any error is detected by the error detector 211 or if the result of comparison by the ID comparer 215 is “inconsistency”, the register writing controller 217 does not perform the writing of the data to the second storage unit 22. In other words, a process to set the value of the register is not performed.

Next, the functions of the first serial interface unit 11 and the second sub serial interface unit 21S in the first slave device 10 will be described. The second sub serial interface unit 21S includes an error detector 211S, a data receiver 212S, a slave ID updater 213S, an ID initial value storage 214S, an ID comparer 215S, the slave ID storage 216S, a register writing controller 217S, a register address holder 218S, and a writing data holder 219S. The functions of theses blocks are the same as the functions of the corresponding blocks in the second serial interface unit 21.

The initial value of the ID stored in the ID initial value storage 214S in the second sub serial interface unit 21S is the same as the initial value of the ID stored in the ID initial value storage 214 in the second serial interface unit 21. The command to update the slave ID is received by both the second serial interface unit 21 and the second sub serial interface unit 21S, and the value of the slave ID storage 216 in the second serial interface unit 21 and the value of the slave ID storage 216S in the second sub serial interface unit 21S are concurrently updated. Accordingly, the value in the slave ID storage 216 in the second serial interface unit 21 is constantly the same as the value in the slave ID storage 216S in the second sub serial interface unit 21S. The value stored in the slave ID storage 216S is the same as the value stored in the specific slave ID register 226S (FIG. 2B) in the second sub storage unit 22S.

Since the functions of the first serial interface unit 11 are the same as the functions of the second serial interface unit 21, the detailed description of the functions of the first serial interface unit 11 is omitted herein. The initial value of the slave ID in the first serial interface unit 11 is different from the initial value of the slave ID in the second serial interface unit 21.

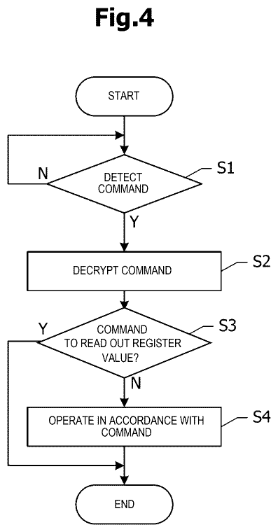

A processing procedure performed by the second sub serial interface unit 21S (FIG. 1) in the first slave device 10 will now be described with reference to FIG. 4. FIG. 4 is a flowchart indicating the processing procedure performed by the second sub serial interface unit 21S (FIG. 1) in the first slave device 10. The second sub serial interface unit 21S receives the command for the second slave device 20 (Step S1) and decrypts the command (Step S2).

If the received command is the command to read out the value of a resistor, a process to read out the value of the register is not performed and a command receiving process is terminated. The second serial interface unit 21 in the second slave device 20 to which the same slave ID #2 as the slave ID #2 in the second sub serial interface unit 21S is allocated also receives the same command. The second serial interface unit 21 reads out the value of the register in response to the received command and transmits a reply message to the master device 30.

If the command received by the second sub serial interface unit 21S is not the command to read out the value of a register, the second sub serial interface unit 21S performs an operation in accordance with the content of the command (Step S4). If the receiving process of one command is terminated, the processing procedure indicated in FIG. 4 is restarted and the detection process of the next command is performed.

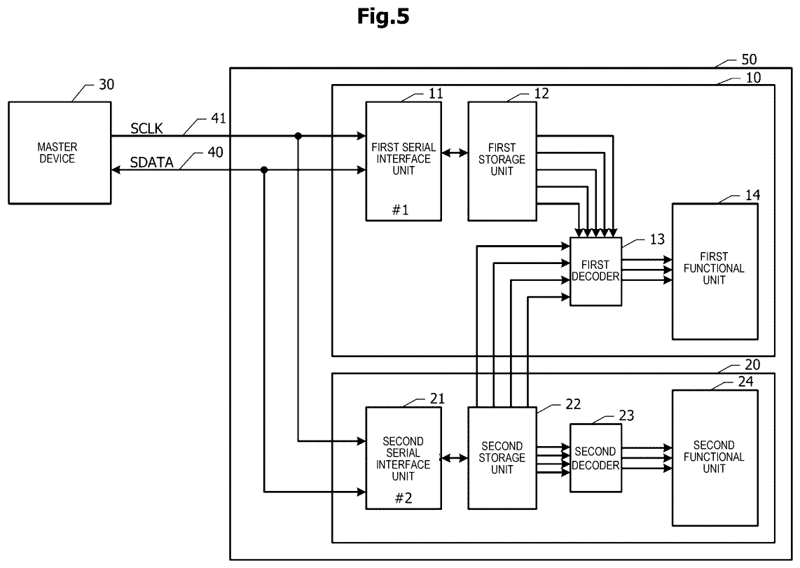

Next, the advantages of the first embodiment will be described while comparing the first embodiment with a comparative example illustrated in FIG. 5.

FIG. 5 is a block diagram of the communication module 50 according to the comparative example. The first slave device 10 in the communication module 50 according to the comparative example differs from the first embodiment (FIG. 1) in that the first slave device 10 in the communication module 50 according to the comparative example does not include the second sub serial interface unit 21S and the second sub storage unit 22S. Instead of this, the information stored in the second storage unit 22 in the second slave device 20 is supplied to the first decoder 13 in the first slave device 10. Accordingly, the number of lines between the first slave device 10 and the second slave device 20 is increased.

The lines with which the first slave device 10 is connected to the second slave device 20 are arranged in a module substrate on which the first slave device 10 and the second slave device 20 are mounted. Since it is necessary to ensure the space to lay out the lines in the module substrate, the size of the communication module 50 is increased.

In contrast, in the first embodiment, since the second sub storage unit 22S storing the information to be input into the first decoder 13 is arranged in the first slave device 10, it is not necessary to provide the lines for transferring the information in the second storage unit 22 between the first slave device 10 and the second slave device 20. Accordingly, it is possible to reduce the size of the communication module 50.

Upon reception of the command to update the slave ID #2, the second serial interface unit 21 in the second slave device 20 updates the slave ID #2 of the second slave device 20. This command is also received by the second sub serial interface unit 21S in the first slave device 10, and the second sub serial interface unit 21S updates the slave ID #2 in the second sub serial interface unit 21S. Accordingly, inconsistency of the value of the slave ID #2 does not occur between the second serial interface unit 21 in the second slave device 20 and the second sub serial interface unit 21S in the first slave device 10.

If any error exists in the command for the second slave device 20, which is transmitted via the serial bus 40, the error is detected in the second slave device 20 and the process to rewrite the register in accordance with the command is not performed. In the first embodiment, the error detector 211S (FIG. 3) in the second sub serial interface unit 21S in the first slave device 10 has a function to detect the reception error of the command, which is similar to that of the error detector 211 (FIG. 3) in the second serial interface unit 21 in the second slave device 20.

Accordingly, if any error exists in the command for the second slave device 20, which is transmitted via the serial bus 40, the error is detected also in the second sub serial interface unit 21S in the first slave device 10 and the process to rewrite the register in accordance with the command is not performed. Accordingly, inconsistency does not occur between the value of the register in the second storage unit 22 and the value of the register in the second sub storage unit 22S. As a result, it is possible to keep matching in the operation between the first functional unit 14 in the first slave device 10 and the second functional unit 24 in the second slave device 20.

In the first embodiment, even upon reception of the command to read out the value of a register, the second sub serial interface unit 21S (FIG. 1) in the first slave device 10 does not perform the process to read out the register (Step S3 in FIG. 4). Accordingly, contention is avoided, in which both the second serial interface unit 21 (FIG. 1) and the second sub serial interface unit 21S (FIG. 1) respond to one command to read out the register in which the slave ID #2 of the second slave device 20 is set.

Next, a modification of the first embodiment will be described.

Although the first slave device 10 and the second slave device 20 are connected to the serial bus 40 in the first embodiment, three or more slave devices may be connected to the serial bus 40. When the content of the storage units of not only the second slave device 20 but also another slave device (for example, a third slave device) is used in the operation of the first slave device 10, the first slave device 10 desirably includes a third sub serial interface unit and a third sub storage unit. The third sub serial interface unit in the first slave device 10 receives a command for the third slave device and performs a process corresponding to the command. The value of the register in the third sub storage unit in the first slave device 10 is the same as the value of the corresponding register in the storage unit in the third slave device. At this time, the first decoder 13 transmits the control value based on the values of the registers in the first storage unit 12, the second sub storage unit 22S, and the third sub storage unit to the first functional unit 14.

When at least one slave device (for example, the third slave device) other than the first slave device 10 operates using the value in the storage unit in another slave device, the third slave device desirably includes a sub serial interface unit and a sub storage unit having the same functions as the second sub serial interface unit 21S and the second sub storage unit 22S, respectively, in the first slave device 10 (FIG. 1).

### Second Embodiment

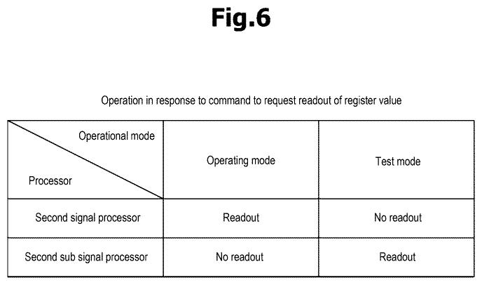

A communication module according to a second embodiment will now be described with reference to FIG. 6. Description of components common to the communication module according to the first embodiment, which are described above with reference to FIG. 1 to FIG. 4, is omitted herein.

The communication module according to the second embodiment has an operating mode and a test mode as operational modes. The operational modes are set by the second serial interface unit 21 and the second sub serial interface unit 21S that receive the command for the second slave device 20. FIG. 6 is a table indicating whether the second sub serial interface unit 21S (FIG. 1) in the first slave device 10 and the second serial interface unit 21 in the second slave device 20 read out the values of the registers when the second sub serial interface unit 21S in the first slave device 10 and the second serial interface unit 21 in the second slave device 20 receive the command for the second sub serial interface unit 21S and the second serial interface unit 21, respectively, which requests readout of the value of the register.

When the operational mode is the operating mode, upon reception of a command to request readout of the value of the register, the second serial interface unit 21 reads out the value of the register and returns a message to the master device 30. Although the second sub serial interface unit 21S also receives the same command at this time, the second sub serial interface unit 21S does not read out the value of the register and does not send a reply to the master device 30. When the operational mode is the test mode, either of setting in which the second serial interface unit 21 does not read out the value of the register and setting in which the second sub serial interface unit 21S does not read out the value of the register is available. When the setting in which the second serial interface unit 21 does not read out the value of the register is made, the second serial interface unit 21 does not send a reply to the master device 30. Instead of this, the second sub serial interface unit 21S reads out the value of the register and returns a message to the master device 30.

Since only one of the second serial interface unit 21 and the second sub serial interface unit 21S returns a message when the master device 30 sets the slave ID of the second slave device 20 and transmits the command to request readout of the value of the register, the contention of the reply message is avoided.

Next, the advantages of the second embodiment will be described.

In the second embodiment, setting the operational mode of the second sub storage unit 22S to the test mode enables the master device 30 to read the value of the register in the second sub storage unit 22S. Accordingly, it is easy to test and debug the communication module.

### Third Embodiment

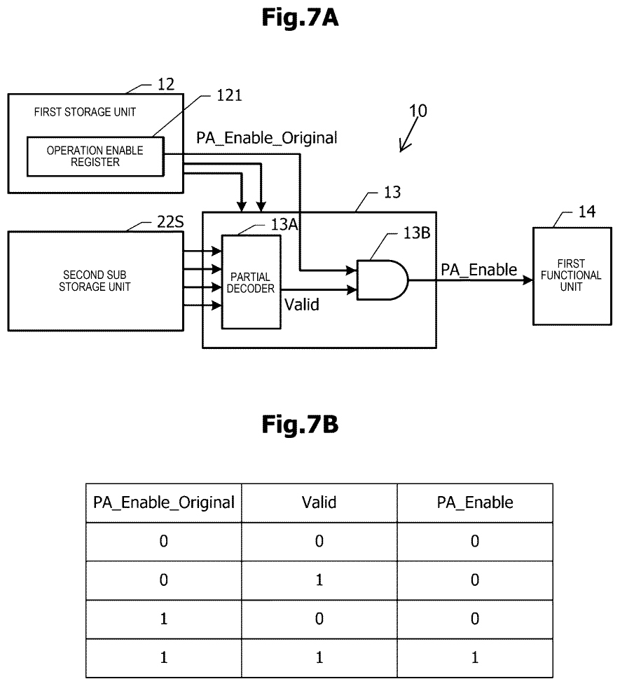

A communication module according to a third embodiment will now be described with reference to FIG. 7A and FIG. 7B. Description of components common to the communication module according to the first embodiment, which are described above with reference to FIG. 1 to FIG. 4, is omitted herein.

FIG. 7A is a block diagram of the part of the first slave device 10 in the communication module according to the third embodiment. The first storage unit 12 includes an operation enable register 121 that specifies whether the first functional unit 14 is set to an enabled state. A setting value PA_Enable_Original of the operation enable register 121 can have a value “Enabled: 1” or a value “Disabled: 0”. The setting value PA_Enable_Original that has the value “Enabled: 1” means that the first slave device 10 has received a command to operate the first functional unit 14.

The first decoder 13 includes a partial decoder 13A and an enable determinator 13B. The values of several registers in the second sub storage unit 22S are decoded by the partial decoder 13A and an output value Valid is outputted. The output value Valid can have a value “Valid: 1” or a value “Invalid: 0”. The output value Valid that has the value “Invalid: 0” means that inconvenience may occur in a cooperation between the first functional unit 14 and the second functional unit 24 because the setting value of the second storage unit 22 in the second slave device 20 is not normal in the operation of the first functional unit 14.

The enable determinator 13B outputs an output value PA_Enable based on the setting value PA_Enable_Original and the output value Valid. The output value PA_Enable can have a value “Enabled state: 1” or a value “Disabled state: 0”.

FIG. 7B is a truth table of the setting value PA_Enable_Original, the output value Valid, and the output value PA_Enable. The enable determinator 13B is composed of an AND circuit and the value of the output value PA_Enable is set to “Enabled state: 1” only when the value of the setting value PA_Enable_Original is set to “Enabled: 1” and the value of the output value Valid is set to “Valid: 1”.The value of the output value PA_Enable is set to “Disabled state: 0” otherwise.

In other words, only when the value of the register in the second sub storage unit 22S is valid, the first functional unit 14 is set to the enabled state. In this case, the first functional unit 14 works.

Next, the advantages of the third embodiment will be described.

In the third embodiment, upon reception of the command to operate the first functional unit 14 in the first slave device 10, if information used for controlling the second functional unit 24 in the second slave device 20, that is, the value of the register in the second sub storage unit 22S does not meet the condition to operate the first functional unit 14 (if the value of the output value Valid is set to “Invalid: 0”), the first functional unit 14 does not work. Accordingly, occurrence of inconvenience in the cooperation between the first functional unit 14 and the second functional unit 24 is avoided.

For example, when the first functional unit 14 is the power amplifier and the second functional unit 24 is the antenna switch that sets a transmission path between the power amplifiers and the antennas, if the power amplifier is operated in a state in which the setting of the antenna switch is not normal, the power amplifier may fail to operate. In the third embodiment, the power amplifier does not work if the setting of the antenna switch is not normal. Accordingly, it is possible to prevent any failure of the power amplifier caused by inconsistency of the state of the first slave device 10 and the state of the second slave device 20.

The respective embodiments described above are only examples and partial replacement or combination of components described in different embodiments is available. The same effects and advantages of the same components in multiple embodiments will not be successively described in the embodiments. In addition, the present disclosure is not limited to the above embodiments. For example, it is obvious to the person skilled in the art to make various modifications, improvements, combinations, and so on.
10 first slave device
11 first serial interface unit
12 first storage unit
13 first decoder
13A partial decoder
13B enable determinator
14 first functional unit
20 second slave device
21 second serial interface unit
21S second sub serial interface unit
22 second storage unit
22S second sub storage unit
23 second decoder
24 second functional unit
30 master device
40 serial bus
41 clock line
50 communication module
121 operation enable register
211, 211S error detector
212, 212S data receiver
213, 213S slave ID updater
214, 214S ID initial value storage
215, 215S ID comparer
216, 216S slave ID storage
217, 217S register writing controller
218, 218S register address holder
219, 219S writing data holder
221 first control register
222, 222S second control register
223, 223S low power mode setting register
224, 224S product ID_1 register
225, 225S manufacturer ID register
226, 226S specific slave ID register
227, 227S product ID_2 register
228, 228S group slave ID register
229, 229S error and reset register
230 Fuse register
231 adjustment register

1. A communication module comprising:
a first slave device and a second slave device which are connected to a serial bus and to which different slave identifiers are added,
wherein the second slave device comprises:
a second storage comprising a plurality of registers, and
a second serial interface configured to receive a second command in which the slave identifier of the second slave device is set via the serial bus and that sets a result of a process corresponding to the received second command in at least one register in the second storage,
wherein the first slave device comprises:
a first storage comprising a plurality of registers,
a second sub storage comprising at least one register,
a first serial interface configured to receive a first command in which the slave identifier of the first slave device is set via the serial bus and that sets a result of a process corresponding to the received first command in at least one register in the first storage, and
a second sub serial interface configured to receive a second sub command in which the slave identifier of the second slave device is set via the serial bus and that sets a result of a process corresponding to the received command in the at least one register in the second sub storage,
wherein the second serial interface is configured to detect any command reception error and, upon detection of the reception error, is configured to not set the value of the register in the second storage, which corresponds to the command in which the reception error is detected, and
wherein the second sub serial interface is configured to detect any command reception error and, upon detection of the reception error, is configured to not set the value of the second sub register in the second sub storage, which corresponds to the command in which the reception error is detected.

2. The communication module according to claim 1,
wherein, upon reception of a command to update the slave identifier, the second serial interface is configured to update the slave identifier of the second slave device in accordance with content of the received command, and
wherein, upon reception of a command to update the slave identifier for the second slave device, the second sub serial interface is configured to update the slave identifier in the second sub serial interface in accordance with content of the received command.

3. The communication module according to claim 1,
wherein, upon reception of a command to read out a value of a register in the second storage, the second serial interface is configured to return a message including the value of the register in the second storage, and
wherein, even upon reception of the command to read out a value of a register in the second storage, the second sub serial interface is configured to not return a message.

4. The communication module according to claim 3,
wherein, upon reception of a command to read out a value of a register in the second sub storage, the second sub serial interface is configured to return a message including the value of the register in the second sub storage.

5. The communication module according to claim 1, wherein part of the plurality of registers in the second storage is included in the second sub storage, and the remaining registers are not included in the second sub storage.

6. The communication module according to claim 1,
wherein the first slave device is further configured to perform a first process corresponding to values set in the registers in the first storage and a value set in the register in the second sub storage, and
wherein the second slave device is further configured to perform a second process corresponding to values set in the registers in the second storage.

7. The communication module according to claim 6,
wherein the first storage comprises an operation enable register that specifies whether the process is enabled, and
wherein the first slave device further comprises an enable determinator that is configured to determine whether the value of the register in the second sub storage is normal in an operation of the first process and that, if the value of the register in the second sub storage is not normal, is configured to not enable the first process regardless of the value of the operation enable register.
